(19) United States
(12) Patent Application Publication
(10) Pub. No.: US 2011/0030323 A1
(43) Pub. Date: Feb. 10, 2011

(54) DISCHARGING AIR FILTER

(76) Inventors: Wade D. Vinson, Magnolia, TX (US); John P. Franz, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/937,943

(22) PCT Filed: May 7, 2008
(86) PCT No.: PCT/US08/62925

§ 371 Date: Oct. 14, 2010

(51) Int. Cl. B01D 46/10; B01D 46/18

(52) U.S. Cl. 55/385.1

(57) ABSTRACT

An apparatus comprises a moving, continuously cleaning filter that removes contaminants from air as the air enters an equipment rack and discharges the contaminants into the air as the air exits the equipment rack.

### BACKGROUND

The proliferation of computer use in commercial enterprise has resulted in computers placed in a myriad of locations that are environmentally hazardous to the computers. Such locations include dusty shipping platforms, high temperature construction locations, etc. As such, computers benefit from filters that keep the computers substantially free of dust and increase airflow through the computer. However, filters clog quickly if not continually serviced, and excessive clogging leads to an increase in computer temperature causing debilitating overheating. As such, efficient, long-lasting filters, which would spare money, time, and outages, are desired not only for computers but other applications as well.

### BRIEF DESCRIPTION OF THE DRAWINGS

For a more complete understanding of the present disclosure, reference is now made to the accompanying drawings and detailed description, wherein like reference numerals represent like parts:

FIG. 1 illustrates an overhead cross-sectional view of a filter in accordance with at least some illustrative embodiments; and

FIG. 2 illustrates an overhead cross-sectional view of a system comprising the filter of FIG. 1 and an equipment rack in accordance with at least some illustrative embodiments.

### NOTATION AND NOMENCLATURE

Certain terms are used throughout the following claims and description to refer to particular components. As one skilled in the art will appreciate, different entities may refer to a component by different names. This disclosure does not intend to distinguish between components that differ in name but not function. In the following discussion and in the claims, the terms “including” and “comprising” are used in an open-ended fashion, and thus should be interpreted to mean “including, but not limited to . . . .” Additionally, the term “system” refers to a collection of two or more hardware components.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. The discussion of any embodiment is meant only to be illustrative of that embodiment, and not intended to intimate that the scope of the disclosure, including the claims, is limited to that embodiment.

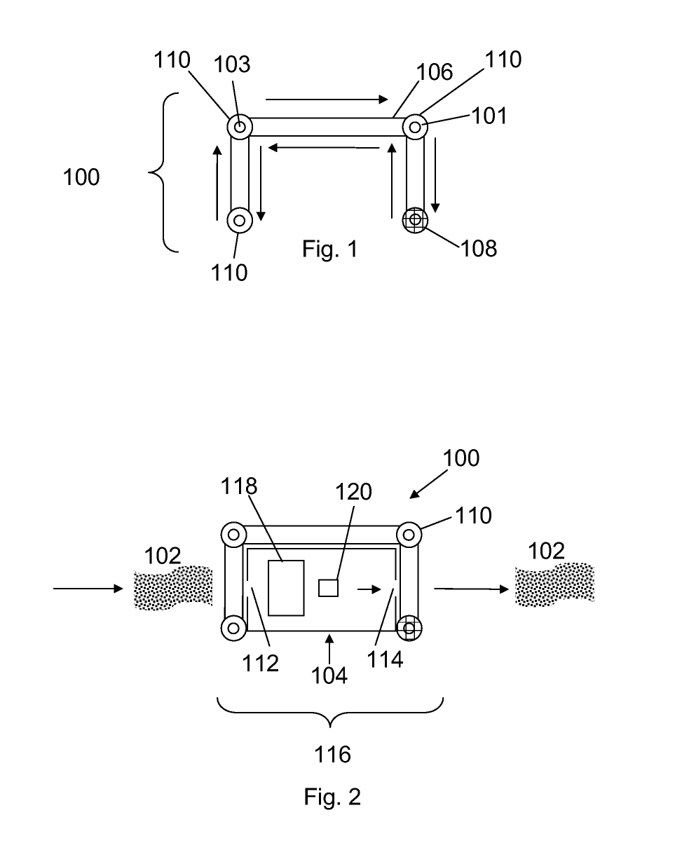

To overcome the obstacles described above, an apparatus and systems are disclosed that remove the necessity for frequent fitter replacement even in noxious environments. FIG. 1 illustrates an overhead cross-sectional view of an apparatus comprising a filter 100. The filter comprises a permeable substrate 106. The permeable substrate 106 preferably is a contiguous loop of any permeable material that does not substantially impede the progress of air through the material but does not allow contaminants through the material. Any such material in any shape is within the scope of this disclosure. The contaminants are preferably dust and dust-like particles that, over time, would adversely impact the equipment protected by the filter 100. Preferably, the contiguous loop is a rectangular piece of material that has the short sides joined in order to create a continuous surface, similar to a conveyer or serpentine belt. In at least one embodiment, the permeable substrate 106 is not strictly contiguous, but has segments missing. The missing segments section the permeable substrate 106 for cost savings, identification purposes, or design requirements, but add an additional layer of complexity as the permeable substrate moves, described below. However, any configuration of the permeable substrate 106 is within the scope of this disclosure.

In at least one embodiment, the apparatus comprises rollers 110. Preferably, each roller 110 comprises a movable outer cylindrical member 101 rotatably coupled to a fixed inner cylindrical member 103; however any configuration, shape, and number of rollers are within the scope of this disclosure. For example, in at least one embodiment, the rollers 110 are conical. In at least one embodiment, rotation of the outer member 101 can occur in either direction about the inner member 103, clockwise and counterclockwise as illustrated. In at least one embodiment, the rollers 110 comprise only a single member rotating about an axis of rotation. The permeable substrate 106 is preferably coupled to the rollers 110 via tension, the portions of the permeable substrate 106 contacting the outer members 101 of the rollers 110 and exerting pressure in the direction of the inner member 103. As such, the permeable substrate 106 can move in the directions indicated by the arrows of FIG. 1 and be guided by the rollers 110 as the outer members 101 rotate about the inner members 103. However, any method suitable for coupling the permeable substrate 106 to the rollers 110 is within the scope of this disclosure.

In at least one embodiment, the filter 100 comprises a motor 108. Preferably, the motor 108 is housed within one of the rollers 110. As illustrated, the motor is housed within the cylindrical members 101, 103 of the lower right roller 110. However, multiple motors and alternate housing are within the scope of this disclosure. Preferably, the motor 108 causes the lower right roller 110 to rotate clockwise, and the entire permeable substrate 106 moves in the direction indicated by the arrows of FIG. 1 as a result. However, any method suitable for moving the permeable substrate 106 is within the scope of this disclosure. The movement of the permeable substrate 106 is guided and facilitated by the non-motorized rollers, and the tension between the permeable substrate 106 and the non-motorized rollers causes the non-motorized rollers to rotate clockwise as well. In at least one embodiment, any roller 110 may be swapped with any other roller 110, whether motorized or not, without reducing functionality as long as there is one motorized roller present. Also, in at least one embodiment, the filter 100 comprises more than one motorized roller.

FIG. 2 illustrates an overhead cross-sectional view of a system comprising the filter of FIG. 1 and an equipment rack 104. Preferably, the filter 100 is coupled to an equipment rack 104, forming a system 116. In at least one embodiment, each roller 110 comprises a base that is fastened to the equipment rack 104; however, any method of coupling is within the scope of this disclosure. The equipment rack 104 is preferably a housing of a dimension and material sufficient to house and protect equipment 118 enclosed within the rack 104. Preferably, the equipment 118 is electronic circuitry that should be substantially free of contaminants 102 and should be kept within operational temperatures. However, any type of equipment that can be adversely affected by contaminants 102 is within the scope of this disclosure. In at least one embodiment, the equipment rack 104 houses one or more of computers or computing elements such as data storage elements, processing elements, networking elements, etc. As such, the equipment rack 104 is preferably a computer rack.

The equipment rack 104 preferably comprises an air intake 112 and an air exhaust 114. The air intake 112 and air exhaust 114 promote air flow through the equipment rack 104, keeping the equipment 118 cool, by allowing air to enter the air intake 112 and exit the air exhaust 114 in the directions indicated by the arrows in FIG. 2. As such, the air intake 112 and air exhaust 114 comprise breaks in the continuity of the equipment rack 104. As illustrated, the air intake 112 and air exhaust 114 are on opposite sides of the equipment rack 104, though multiple intakes and exhausts on any or the same side of the equipment rack 104 is within the scope of this disclosure.

Preferably, the equipment rack 104 also comprises a fan 120 to promote air flow as well. The fan 120 may be of any suitable dimension or material, and in at least one embodiment, the fan 120 is integrated into the equipment rack 104. Preferably, temperature within the equipment rack 104 and air flow within the equipment rack 104 is kept within normal operating ranges, or else a computer administrator is alerted. Additionally, use of multiple fans in multiple locations is within the scope of this disclosure.

The permeable substrate 106 preferably guards the air intake 112 and air exhaust 114 such that air traveling through the air intake 112 and air exhaust 114 passes through the permeable substrate 106. As illustrated, the permeable substrate 106 spans three sides of the equipment rack 104 in a serpentine fashion to reach both the air intake 112 and air exhaust 114. However, any number of configurations are possible. For example, in at least one embodiment instead of the illustrated configuration, where the permeable substrate 106 backtracks the route taken from the air intake 112 to air exhaust 114 in order to return to the air intake 114, the permeable substrate 106 traverses the fourth side of the equipment rack 104 to return to the air intake 114. In at least one embodiment, the filter 100 is integrated into the equipment rack 104. As such, the permeable substrate 106 is located between an outer wall of the equipment rack 104 and an inner wall of the equipment rack 104. In at least one other embodiment, the permeable substrate guards the air intake 112 and air exhaust 114 by being placed inside the equipment rack 104. All such configurations of the elements of the system 116 are within the scope of this disclosure.

Turning to operation, preferably the motor 108 moves each section of the permeable substrate 106 from the air exhaust 114 to the air intake 112 by turning the roller 110 in which the motor 118 is housed such that the entire permeable substrate 106 is guided along the rollers 110. In at least one embodiment, the motor 118 is timed to move the permeable substrate 106 a fixed distance periodically. In another embodiment, the motor 108 moves the permeable substrate 106 intermittently based on the amount of contaminants 102 removed from the air. In another embodiment, the motor 108 moves the permeable substrate 106 continuously at a constant or variable speed. Any method of timing the permeable substrate's 106 motion and velocity is within the scope of this disclosure.

The filter 100 removes contaminants 102 from air as the air enters the equipment rack 104 and discharges the contaminants 102 into the air as the air exits the equipment rack 104. Preferably, the permeable substrate 106 removes the contaminants 102 from the air as the air enters air intake 112. After the air deposits the contaminants 102 on a first section, or portion, of the permeable substrate 106 (“section”), guarding the air intake 112, the motor 108 moves the section to the air exhaust 114. A second section of the permeable substrate 106, previously guarding the air exhaust 114, is thus displaced. Preferably, the entire permeable substrate moves along the guiding rollers 110 in the direction indicated by the arrows in FIG. 1 such that the contaminants on the section align with the stream of air exiting the air exhaust 114.

Subsequently, the filter 100 discharges the contaminants 102 into the air as the air exits the equipment rack 104. Preferably, the permeable substrate 106 discharges contaminants 102 into the air as the air exits the air exhaust 114. In at least one embodiment, the fan 120 directs the air in the equipment rack 104 at the contaminants 102 on the section. Concurrently, the second section of the permeable substrate 106 guards the air intake 112 and removes contaminants 102 from the air. After the air exiting the air exhaust 114 has lifted the contaminants 102 off of the section, the section is preferably returned to guard the air intake 112 while the second section is moved to guard the air exhaust 114.

Equipment racks 104, especially computer racks, can be arranged in rows such that a computer administrator walking in the aisle between two rows of equipment racks 104 can access the front of the equipment racks 104 in each row. Preferably, these aisles are kept cool because air from these aisles is drawn into the equipment racks 104 to cool the equipment. Contrastingly, aisles where the computer administrator can access the rear of the equipment racks 104 are hot because the air used to draw heat from the equipment is directed towards the rear of the equipment racks 104. Room air handlers can be used to process or divert air from such hot aisles. In at least one embodiment, the ejected contaminants 102 are collected by these room air handlers such that contaminants from many equipment racks 104 can be aggregated simultaneously by a device dedicated to the purpose.

There are other ways to remove contaminants 102 from the section in addition to blowing the contaminants 102 off of the section, and each way is within the scope of this disclosure. For example, in at least one embodiment, a roller 110 comprises a compartment for storing a liquid cleaning solution that saturates the section as the section passes through the roller 100 thus transferring the contaminants 102 to the solution. The contaminant-laden solution is then scraped off of the section by a rubber member as the section passes through a narrow aperture. In another embodiment, a roller is embedded with piezoelectrics that send ultrasonic waves through the section and dislodge the contaminants 102 from the section as the section passes the roller 110. Of course, if desired, the contaminated section can be collected and rolled up along with other contaminated sections for eventual cleaning by hand or replacement. As such, resources may be conserved, especially if the permeable substrate is inexpensive. Each of these and other methods is within the scope of this disclosure.

Similarly, there are differing strategies available regarding when the permeable substrate 106 should be moved. For example, the motor 108 may move the section of the permeable substrate 106 from the air intake 112 after a threshold of contaminants 102 has been reached or a threshold time has passed. The motor 108 may move the section all the way to the air exhaust 114 for cleaning, or merely part of the way if the desired result is solely to put a second section at the air intake 112. If moved to the air exhaust 114, the motor may move the permeable substrate 106 again once a certain threshold of contaminants 102 have been removed from the section, or it may ignore the section and only move when the second section (now at the air intake 112) reaches the threshold of contaminants 102, etc. Another type of strategy involves the motor 108 moving the permeable substrate 106 continuously at a constant rate. As can be appreciated, there are many strategies that can be implemented, and all strategies are within the scope of this disclosure. As such, the filter 100 disclosed is efficient, long-lasting, self-cleaning, clogs less frequently (thus keeping equipment 118 within normal operating ranges), and requires infrequent service, all of which spares resources and outages in a variety of applications and settings.

The above disclosure is meant to be illustrative of the principles and various embodiment of the present invention. Numerous variations and modifications will become apparent to those skilled in the art once the above disclosure is fully appreciated. It is intended that the following claims be interpreted to embrace all variations and modifications.

What is claimed:

1. An apparatus, comprising a filter that removes contaminants from air as the air enters an equipment rack and discharges the contaminants into the air as the air exits the equipment rack, the filter further comprising a motor.

2. The apparatus of claim 1, wherein the filter comprises a permeable substrate that removes contaminants from the air as the air enters the equipment rack and discharges the contaminants into the air as the air exits the equipment rack, and the motor moves the permeable substrate.

3. The apparatus of claim 2, wherein the filter further comprises a plurality of rollers that guide the permeable substrate.

4. The apparatus of claim 2, wherein the motor moves a section of the permeable substrate from an air intake of the equipment rack to an air exhaust of the equipment rack, the air intake allowing the air to enter the equipment rack, the air exhaust allowing the air to exit the equipment rack.

5. The apparatus of claim 4, wherein the motor moves the section of the permeable substrate from the air exhaust to the air intake.

6. The apparatus of claim 2, wherein the motor moves the permeable substrate at a constant rate.

7. The apparatus of claim 2, wherein the motor moves the permeable substrate intermittently.

8. The apparatus of claim 3, wherein a roller out of the plurality of rollers stores a liquid used in cleaning the permeable substrate.

9. The apparatus of claim 9, wherein the motor moves the permeable substrate based on the amount of contaminants removed from the air.

10. A system, comprising:
an equipment rack; and
a filter, coupled to the equipment rack, that removes contaminants from air as the air enters the equipment rack and discharges the contaminants into the air as the air exits the equipment rack.

11. The system, of claim 10, wherein the equipment rack further comprises a fan that directs the air at the contaminants on the filter, thus discharging the contaminants into the air as the air exits the equipment rack.

12. The system of claim 10, wherein the filter is integrated into the equipment rack.

13. The system of claim 10, wherein the equipment rack comprises an air intake allowing air to enter the equipment rack, the air intake guarded by a first section of the filter.

14. The system of claim 13, wherein the equipment rack comprises an air exhaust allowing air to exit the equipment rack, the air exhaust guarded by a second section of the filter.

15. The system of claim 14, wherein the air intake and the air exhaust are located on opposite sides of the equipment rack.

16. The system of claim 14, wherein the first section of the filter removes the contaminants from the air as the air enters the equipment rack.

17. The system of claim 16, wherein the first section of the filter moves to guard the air exhaust, thus displacing the second section of the filter.

18. The system of claim 17, wherein the first section of the fitter discharges the contaminants into the air as the air exits the equipment rack.

19. The system of claim 18, wherein the first section of the filter moves to guard the air intake.

20. A system, comprising:
a means for housing equipment; and
a means for removing contaminants from air as the air enters the means for housing equipment and discharging the contaminants into the air as the air exits the means for housing equipment.

21. A system, comprising:
an equipment rack comprising an air intake;
a filter coupled to the equipment rack, the filter comprising a permeable substrate, the permeable substrate removing contaminants from air as the air enters the air intake; and
a motor coupled to the filter, the motor moving the permeable substrate across the air intake;
wherein the permeable substrate is collected after moving across the air intake and the permeable substrate is replaced after the permeable substrate is collected.
